(19) United States
(12) Patent Application Publication
(10) Pub. No.: US 2002/0086192 A1
(43) Pub. Date: Jul. 4, 2002

(54) Separation of carbon monoxide from a reformer gas

(76) Inventor: Gene E. Lightner, Federal Way, WA (US)

Correspondence Address: Gene E. Lightner, 706 SW 296 St., Federal Way, WA, 98023, US

(21) Appl. No.: 09/751,136

(22) Filed: Dec. 29, 2000

(51) Int. Cl. H01M 8/06; C01B 3/26

(52) U.S. Cl. 429/17; 423/652

(57) ABSTRACT

A method to separate carbon monoxide from a gas obtained from a fuel reformer containing hydrogen and carbon monoxide is outlined. Reformer gas containing carbon monoxide is subjected to a steam shift reaction to produce additional hydrogen and reduce carbon monoxide to form carbon dioxide. Mingling the resulting gas in an alcohol capable of dissolving carbon monoxide forms a gas containing hydrogen substantially devoid of carbon monoxide. The alcohol containing dissolved carbon monoxide is then recycled to the reformer to repeat the method. The gas, substantially free of carbon monoxide containing carbon dioxide, is subjected to a solution capable of substantially removing carbon monoxide from the gas by scrubbing. The solution containing dissolved carbon dioxide is heated to produce gaseous carbon dioxide and a solution, for recycling toward additional scrubbing. The resulting gas is subjected to a medium for scrubbing the gas as a means for purification. The gas containing hydrogen, substantially devoid of carbon monoxide, will provide significantly purified hydrogen without employing a membrane. The medium employed for scrubbing, containing volatile components from the gas, is then heated to produce vapor and a medium to be recycled for additional scrubbing. The resulting vapor is combined with reformer gas and accordingly recycled.

### BACKGROUND OF THE INVENTION

Present day motor vehicles employ internal combustion engines operating with petroleum based liquid fuels. In the future internal combustion engines will, in all likelihood, be replaced with other power sources such as hydrogen based fuel cells pictured by Argonne National laboratory in “Fuel reformer brings practical electric cars closer,” in which development of partial oxidation methanol reformer is discussed. Several state of the art methods for forming hydrogen employing a steam reformer are described in U.S. Pat. Nos. 5,997,594, 5,639,431 and 5,938,800 converting fuel to form hydrogen. Several state of the art methods for forming hydrogen employing a partial oxidation reformer are disclosed in U.S. Pat. Nos. 5,942,346 and 4,789,540 for converting fuel to form hydrogen. The hydrogen will be used to supply power for the motor vehicles to form a water vapor which is pollution free. The problem with hydrogen powered vehicles is apparently the lack of a low cost practical mobile supply of hydrogen and insufficient range of distance. A mobile supply of hydrogen gas containing carbon monoxide and carbon dioxide is supplied from liquid fuel by a mobile reforming method selected from the group consisting of autothermal reforming and partial oxidation reforming including an individual or a combination of reforming methods. The resulting hydrogen gas is often separated by a membrane permeable to hydrogen to provide power to a fuel cell located in a vehicle without requiring hydrogen storage. The gas from the reformer commonly contains toxic carbon monoxide which should conceivably be converted to non-toxic carbon dioxide prior to releasing to the air.

It is therefore an object of this invention to obviate many of the limitations or disadvantages of the prior art.

The present concern is about carbon monoxide derived from a liquid fuel from a reforming method employed to form hydrogen without employing a hydrogen permeable membrane.

A distinct object of this invention is to provide separation and substantial reduction of carbon monoxide from a reformer gas containing hydrogen.

Still another object of this invention is to provide a liquid fuel to dissolve carbon monoxide.

Yet another object of this invention is to provide a vessel to separate carbon monoxide which accompanies a fuel cell located in a vehicle.

With the above and other objects in view, this invention relates to the novel features and alternatives and combinations presently described in the brief description of the invention.

### APPLICATIONS AND BACKGROUND OF THE INVENTION

Several solvents to dissolve carbon monoxide are disclosed in the Merck Index, eighth edition, 1968, pages 208-209. Inorganic solvents include a concentrated solution of cuprous chloride in HCL and NH₄OH. and organic solvents such as ethyl acetate, CHCl₂, and acetic acid. Also disclosed are organic solvents including methanol and ethanol. Methanol or ethanol can be employed as a liquid fuel capable of dissolving carbon monoxide, supplied from a fuel tank located in a vehicle. Methanol or ethanol containing dissolved carbon monoxide can be employed to supply fuel to a reformer to produce hydrogen. Consequently a gas containing carbon monoxide can be substantially freed of carbon monoxide by employing a liquid fuel capable of dissolving carbon monoxide. The gas free of carbon monoxide likely contains carbon dioxide and can be scrubbed to remove carbon dioxide

One example of scrubbing a gas containing carbon dioxide is described on pages 126 and 127 in Chemical Process Industries, second edition, authored by R. N. Shreve in which sodium carbonate is employed as a medium for scrubbing a flue gas containing carbon dioxide to form water soluble sodium bicarbonate ions. The solution containing sodium bicarbonate is then heated to produce concentrated carbon dioxide and a solution containing sodium carbonate to be recycled. Shreve, op. cit., pages 131 and 132, describes a method to absorb carbon dioxide in an aqueous solution of mono ethanolamine, to provide a medium, in which the absorbed carbon dioxide is removed from the aqueous solution to produce carbon dioxide as a gas. The medium is often selected from the group consisting of aqueous bases and aqueous salts including an individual or a combination of these. There are also miscellaneous methods to remove impurities from a gas. The medium for scrubbing may be selected from the group consisting of silica gel and alumina including an individual or a combination of these media.

Shifting a gas obtained from a fuel reformer containing hydrogen and carbon monoxide is customarily achieved with water or steam to shift carbon monoxide to carbon dioxide. Steam is often reacted with carbon monoxide to shift carbon monoxide, reversibly, to carbon dioxide and hydrogen, as described by Shreve, op. cit., page 136. Also water is reacted with carbon monoxide to shift carbon monoxide to carbon dioxide and hydrogen, as summarized by Shreve, op. cit., page 121.

### BRIEF DESCRIPTION OF THE INVENTION

The present invention in its broadest aspect, provides a method to separate carbon monoxide from a fuel reformer gas containing carbon dioxide and hydrogen. The carbon monoxide is generally reacted with steam to convert some of the carbon monoxide to carbon dioxide. A vessel containing a liquid capable of dissolving carbon monoxide, contained in the gas, in used to remove carbon monoxide from the gas obtained from a fuel reformer. By mingling the reformer gas in a liquid capable of dissolving carbon monoxide forms a gas containing hydrogen substantially devoid of carbon monoxide. The gas, substantially free of carbon monoxide, usually contains carbon dioxide. After separating the gas, containing hydrogen substantially devoid of carbon monoxide, from the vessel, the gas is subjected to a medium for scrubbing a gas as a means for purification and removal of carbon monoxide and other impurities from the previously separated gas. The purified gas containing hydrogen is substantially devoid of carbon monoxide and carbon dioxide will produce hydrogen without employing a membrane. Hydrogen produced from a liquid fuel reformer, and separated from a gas containing carbon monoxide, is customarily employed to power a fuel cell located in a vehicle. Hydrogen produced by reforming a liquid fuel regularly contains carbon dioxide and carbon monoxide. Hydrogen is often removed from the gas mixture through a hydrogen permeable membrane.

Characteristics of the invention include;

A liquid fuel containing hydrogen may be converted to form hydrogen and carbon monoxide by any reforming method including steam reforming, autothermal reforming, partial oxidation reforming or a combination of any reforming methods.

Providing a liquid fuel such as ethanol or methanol as a liquid fuel subject to reforming.

Conversion of carbon monoxide to carbon dioxide utilizing steam or water.

Separation of carbon gases from hydrogen to produce hydrogen substantially devoid of carbon gases.

Producing of hydrogen from a reformer utilizing a liquid fuel without employing a hydrogen permeable membrane.

Separation of hydrogen from carbon gases to produce hydrogen to power a fuel cell.

Provision of a vessel to dissolve carbon monoxide.

Providing a vessel which accompanies a fuel cell located in a vehicle.

Producing a substantial reduction in air pollution.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims

FIG. 2 is a flow sheet denoting a method to purify hydrogen by a medium and free carbon dioxide from the medium for hydrogen storage and withdrawal.

### DETAILED DESCRIPTION OF THE PREFERRED EMBODIMENT

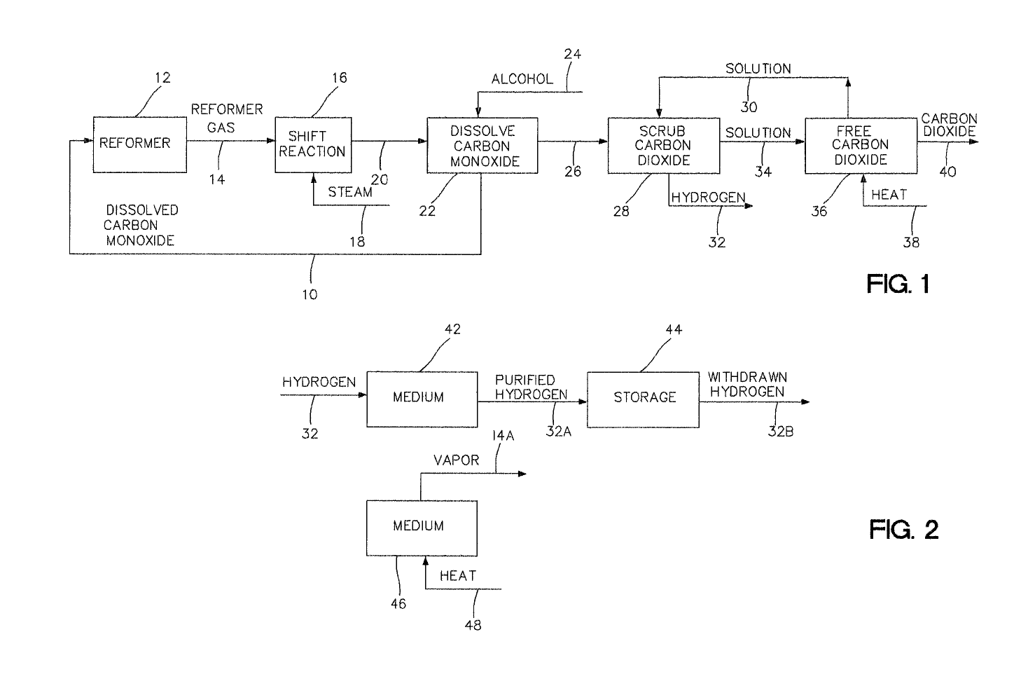

The flow diagram of FIG. 1 illustrates the general preferred embodiment of the present invention. In the diagram, rectangles represent stages, operations or functions of the present invention and not necessarily separate components. Details within each stage, operations or functions are not shown. Arrows indicate direction of flow of material in the method.

Referring to FIG. 1, a supply of a alcohol dissolved in carbon monoxide 10 is furnished to a reformer stage 12 to form a reformer gas 14 containing hydrogen and carbon monoxide. The reformer gas is provided to a shift reaction stage 16 from a supply of steam 18 to form a gas containing hydrogen and carbon monoxide 20. The gas 20 is commingled with alcohol 24 to dissolve carbon monoxide from within the dissolved carbon monoxide gas stage 22 to provide a gas 26 substantially free of carbon monoxide but containing hydrogen and carbon dioxide to furnish a gas to scrub carbon dioxide stage 30 to produce hydrogen 32. Stage 22 also produces solution of dissolved carbon monoxide 34. which is transmitted to free carbon dioxide stage 36 supplied by heat 38 to free carbon dioxide 40 and provide solution 30 for recycle to scrub carbon dioxide stage 30. An alcohol 24 must be capable of dissolving carbon monoxide contained in a gas. Solution 30 is regularly cooled before introduction to scrub carbon dioxide stage 30.

Referring to FIG. 2, a supply of hydrogen 32 is forwarded to medium stage 42 to remove impurities from the supply of hydrogen 32 to provide purified hydrogen 32A. After loading medium stage 42 with impurities, heat 44 is a applied to medium stage 42 to vaporize impurities and produce vapor 14A. Medium 44 is regularly cooled before reuse in medium stage 42. Purified hydrogen 32A is stored in storage 44 and is withdrawn to provide hydrogen 32B.

What is claimed is:

1. A method to separate carbon monoxide from a gas obtained from a fuel reformer containing hydrogen and carbon monoxide, which comprises:
providing a liquid fuel in which said carbon monoxide is dissolved from said gas obtained from said fuel reformer, and
providing said reformer gas containing hydrogen and carbon monoxide, and
providing steam to shift the reformer gas to form hydrogen and carbon dioxide, and
providing solution for removing carbon dioxide from a gas containing hydrogen, and
providing a medium for scrubbing impurities within gaseous hydrogen, and
reacting said reformer gas with steam to shift the reformer gas to form a gas containing hydrogen and carbon dioxide, and
mingling the previously shifted gas in a liquid fuel capable of dissolving said carbon monoxide to form a gas containing hydrogen substantially devoid of carbon monoxide and a liquid fuel containing dissolved carbon monoxide, and
separating said liquid fuel containing dissolved carbon monoxide from the gas containing hydrogen substantially devoid of carbon monoxide, and
recycling said liquid fuel containing dissolved carbon monoxide to said fuel reformer, and
mingling the previously separated gas containing hydrogen substantially devoid of carbon monoxide with a solution for removing carbon dioxide from a gas containing hydrogen, and
separating the gas, containing hydrogen, from the solution containing carbon dioxide, and
subjecting the solution containing carbon dioxide to heat to form carbon dioxide and a solution for recycle thereby producing a gas containing hydrogen substantially devoid of carbon monoxide.

2. The method of claim 1 wherein said reformer gas is produced from a reforming method selected from the group consisting of autothermal reforming and partial oxidation reforming including an individual or combination thereof.

3. The method of claim 1 wherein said liquid fuel is selected from the group consisting of ethanol and methanol including an individual or combination thereof.

4. The method of claim 3 wherein ethanol, containing dissolved carbon monoxide, is recycled to form additional gas obtained from a fuel reformer.

6. The method of claim 1 wherein said carbon monoxide is dissolved within a solution containing cuprous chloride.

7. The method of claim 6 wherein the solution containing cuprous chloride and dissolved carbon monoxide is substantially separated from carbon monoxide dissolved in the liquid.

8. The method of claim 1 wherein said solution for removing carbon dioxide within the gas is selected from the group consisting of aqueous bases and aqueous salts including an individual or combination thereof.

9. The method of claim 1 wherein hydrogen substantially devoid of carbon monoxide is subjected to scrubbing within a medium for scrubbing impurities within gaseous hydrogen to provide a gas containing hydrogen separated from said medium.

10. The method of claim 9 wherein said medium, containing impurities, is subjected to heat forming a vapor containing volatile impurities and a medium for recycle.

11. The method of claim 9 wherein said medium for scrubbing is selected from the group consisting of silica gel and alumina including an individual or combination thereof.

12. The method of claim 9 wherein the gas containing hydrogen substantially devoid of impurities is subjected to storage.

13. The method of claim 12 wherein the gas containing hydrogen subjected to storage is withdrawn from storage.

14. The method of claim 13 wherein the gas containing hydrogen withdrawn from storage is employed to power a fuel cell.
